(19) United States
(12) Patent Application Publication
(10) Pub. No.: US 2004/0025312 A1
(43) Pub. Date: Feb. 12, 2004

(54) Casting roll for casting and/or supporting a cast strand, in particular for a two-roll casting machine

(76) Inventors: Gunter Flemming, Erkrath (DE); Hans Streubel, Erkrath (DE)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/432,104

(22) PCT Filed: Nov. 16, 2001
(86) PCT No.: PCT/EP01/13275

(30) Foreign Application Priority Data
Nov. 29, 2000 (DE) 10059304.6

(51) Int. Cl. B23B 3/16; B23B 7/04

(52) U.S. Cl. 29/46

(57) ABSTRACT

The invention relates to a casting roll for casting and/or supporting a cast strand, in particular for a two-roll casting machine Said casting roll comprises a water cooling system, in which the cooling water is supplied and discharged in cooling channels (8), formed by cooling bores or grooves that are distributed over the periphery of the roll and a pressure chamber (10), which borders a roll casing (5) and is connected in an adjustable manner to a hydraulic fluid source. The casting roll prevents a superelevation of the profile and the formation of a wedge-shape over a significant section of the length of the casting roll, as the internal diameter of the roll casing (5) increases, starting from sealing elements (15) up to the centre of the roll and the hollow chamber (16) can be impinged by the hydraulic fluid in order to modify the profile.

The invention relates to a casting roll for casting and/or supporting a cast strand, especially for a two-roll casting machine with water cooling, whereby the fed cooling water is supplied through cooling channels in the form of cooling bores or cooling grooves which are distributed about the roll periphery and discharged again therefrom, and with a pressure chamber which is controllably connected with a pressure medium source and which is bounded by a peripheral roll shell.

A casting roll as indicated is known from DE 33 36 692 C2. This known method and the casting roll for the continuous casting of metal sheet has in the (cold) starting state a negative camber [bulginess] of the outer peripheral surface, whereby upon the starting of the continuous casting process a pressure is applied to an inner region of the hydraulic chamber so that the outer peripheral surfaces of both rolls will assume a truly cylindrical form. This ensures that the metal strip to be cast will have uniform thickness and the rolls will remain strictly cylindrical.

It is known that a decisive precondition for the final roll profile of two-roll casting and rolling apparatus is the intake profile of the cast strip. The small starting thickness of less than 10 mm, which does not permit any broadening imposes special requirements on the intake profile of the cast strip with respect to a profile superelevation and a wedge shape. In the known two-roll casting machine, the casting rolls are provided with hollow profiles to compensate the thermal roll deformation in the casting range. This compensation should generate the cast profile which is supplied or the inlet profile in the rolling unit.

The different casting parameters, like for example casting speed, contact length as a consequence of different bath level heights, bath level fluctuation or the like give rise to different temperature profiles in the casting roll and thus to different roll profiles which of necessity yield casting profiles or inlet profiles which cannot satisfy the requirements of the rolling unit to reach requisite rolling tolerances with respect to the superelevation of the profile and/or the wedge shape.

The invention has as its object to provide a super-elevation of the profile of the cast product of 0.5 to 3%, especially 1 to 2% by influencing the profile shape in the casting roll as a function of the casting parameters.

The object which has been set out is achieved according to the invention in that the roll shell starting from sealing elements and extending toward the roll center has an increasing internal diameter and the hollow space which is formed is pressurizable with the pressure medium for profile change. The matched enlargement of the internal diameter is so configured that upon an internal pressurization of the roll shell, the outer roll profile can be adjusted in a targeted manner to produce the desired strip profile during the casting. Thus a simple and effective solution of the object is achieved.

In a refinement of the invention it is here proposed that the internal profile of the roll shell match the negative roll profile and that by means of pressurization the profile created in the casting operation is adjustable.

It should be noted that the increase in the diameter of the internal profile is symmetrical to the roll center.

Advantageously, the pressure medium is supplied radially or axially.

A first alternative configuration has the roll shell rotatable on a stationary axle.

In a second alternative the roll shell is arranged on a rotatable shaft.

According to a further feature it is proposed that the ends of the roll shell each have a supply ring housing and a discharge ring housing for the cooling water which flows through cooling channels of the roll shell which are parallel to the axis. As a consequence a simple and low maintenance cooling water feed for the roll is achieved.

A further refinement provides that the pressure feed is fed by means of a rotary passthrough into the hydraulic chamber.

An example of a practical form with stationary axis provides that the pressure fluid can be fed by means of a further rotary-free feedthrough annular housing fastened on the inner sleeve part through at least one radial and one axial pressure channel into the hydraulic chamber. With a configuration with a shaft and a roll shell set thereon, the pressure medium can be introduced via the shaft radially or axially.

The different internal diameters can be effected by a configuration with matched wall thicknesses.

For the control of the profile shape of the roll surface, it is further advantageous that the roll profile of the deformable roll shell is adjustable by means of the fluid pressure as a function of the casting parameters.

Another control possibility, independent of or in conjunction with the aforedescribed control possibility resides in that the roll profile of the deformable roll shell is adjustable by the fluid pressure in dependence upon the force that is effective on the roll body.

Finally there is a third control basis in that the roll profile of the deformable roll shell can be adjustable by the fluid pressure in dependence upon the temperature profile of the roll shell.

According to another feature, the pressure of the pressure fluid can be adjusted between 50 and 500 bar.

In the drawing an example of the invention has been shown which is described in greater detail hereinafter. It shows:

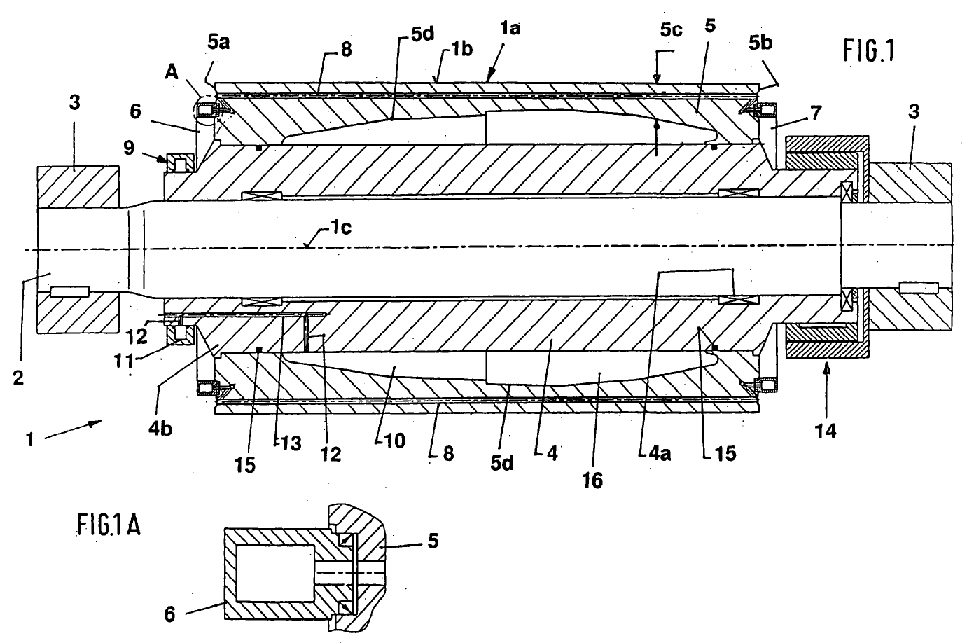

FIG. 1 an axial central section through a roll with a stationary axle,

FIG. 1A a detail “A” from FIG. 1, and

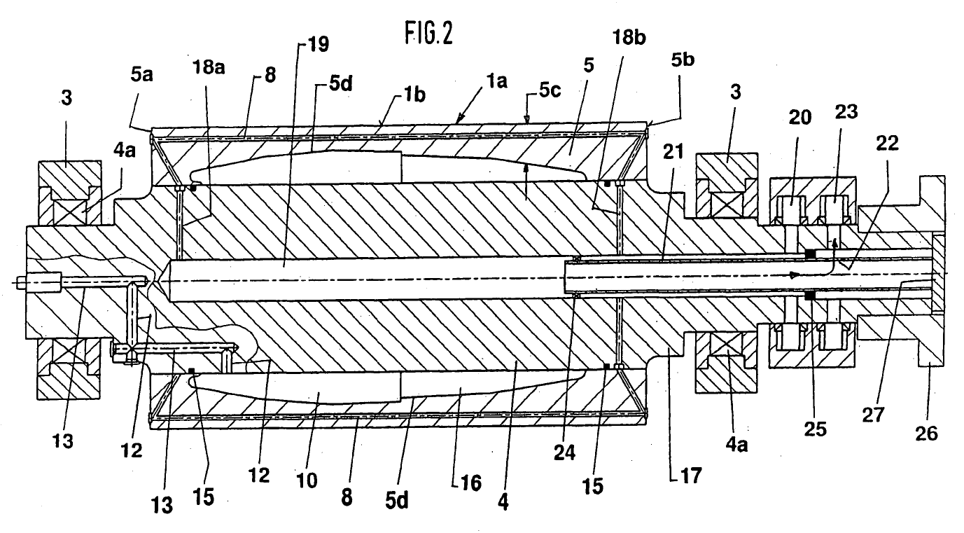

FIG. 2 an axial central section through a roll with rotatably journaled shaft and central feed or cooling medium or the pressure medium.

The casting roll serves for casting and/or support of a casting strand in a parallel double arrangement with two largely structurally identical casting rolls for a two-roll casting machine. The casting rolls have a water cooling whereby in the roll body 1 cooling water is supplied to cooling channels 8 disposed closely beneath the roll surface 1b parallel to the roll 10 axis 1c and then carried off. The cooling channels 8 can, for example, be comprised of cylindrical bores (FIG. 1).

On the stationary axle 2, which is held in lateral support brackets 3, the rotatably drivable roll body 1 is rotatably journaled. The drive of the roll shell 5 is effected via a drive motor 14 which is supported on the housing of the support bracket 3. The roll body 1 is comprised of a largely rigid inner sleeve part 4 which is rotatably journaled on the axle 3 and which is journaled by means of the rotary bearings 4a thereon. The roll body 1 has, in addition, a roll shell 5 which is deformable by internal pressure and which defines a hollow compartment 16 with the deformable roll shell 5 between the sealing planes 15a and which is approximately the same length as the inner sleeve part 4. The roll shell 5 and the inner sleeve part 4 are fixed together for example by a shrink connection and sealed by sealing elements 15.

On the ends 5a and 5b, an annular feed housing 6 and an annular discharge housing 7 are provided for the cooling water which flows through the cooling channels 8 parallel to the axis.

The pressurizing fluid is supplied through a rotary feedthrough 9 on a step 4b of the inner housing part 4. In the embodiment shown by way of example, the rotary feedthrough 9 is comprised of a rotary feedthrough annular housing 11 which, through radial pressurizing channels 12 and an axial pressurizing channel 13 connects the hydraulic chamber 10 with a liquid pressure source (not shown in greater detail).

The outer sleeve 5 has its length divided into parts of wall thicknesses 5c matched with respect to the pressure applied so that the inner profile 5d of the outer shell will generate a mathematically determinable curve shape, for example, a portion of a parabola or the like.

The outer parabola 1a of the deformable roll shell 5 is adjustable by the liquid pressure in dependence upon the casting parameters of the respective cast strand (for example a strip strand of steel).

The roll profile 1a of the deformable roll shell 5 can also be adjusted by the liquid pressure in dependence upon the adjusted force which is effective on the entire roll body 1.

A third possibility of the adjustability is that the roll profile 1a of the deformable roll shell 5 is adjusted by the liquid pressure in dependence upon the measured temperature profile of the outer sleeve 5. It will be self understood that all of these approaches can be used simultaneously or individually.

The pressure of the pressure liquid is set at 50 to 500 bar.

At the right side bracket, the drive motor is an annular torque motor by means of which the tension force on the cast strand and its weight can be detected.

The embodiment of FIG. 2 is based upon a rotatable roll body 1 which has a shaft 17 which is rotatably journaled in the support brackets 3 and carries the roll shell 5. The roll profile 5d is shaped as has been described for the first embodiment. The cooling channels 8 are connected by radial channels 18a to a central tube 19 whereby the cooling medium is fed through a first annular channel 20, over radial channels 18b and is collected in the central tube 19 and carried away through an axial channel tubular segment 21 through bores 22 and through a second annular channel 23.

The axial channel tubular segment 21 is sealed at its outer periphery by respective seals 24 and 25 relative to the central tube 19.

The pressure medium is also fed centrally through the radial pressure channel 12 and the axial pressure channel 13 in the shaft 17 and through radial channels 23 and axial channel segments 24, is fed into the hollow space 16. At the (right) end, a closure flange 26 is provided with a closure cover 27 which closes the central tube 19.

### Reference Character List

1 Roll body

1a Roll profile

1b Roll surface

1c Roll axis

2 Stationary axle

3 Support bracket

4 Inner sleeve part

4a Rotary bearing

4b Shaft step

5 Roll shell

5a End

5b End

5c Wheel thickness

5d Inner profile

6 Supply annular housing

7 Discharge annular housing

8 Cooling channel

9 Rotary feedthrough

10 Hydraulic chamber

11 Further rotary feedthrough annular housing

12 Radial pressure channel

13 Axial pressure channel

14 Drive motor

15 Sealing element

16 Hollow compartment

17 Shaft

18a First radial channel

18b Second radial channel

19 Central tube

20 First annular channel

21 Axial channel tube segment

22 Bore

23 Second annular channel

24 Seal

25 Seal

26 Closure flange

27 Closure cover

1. A casting roll for casting and/or supporting a cast strand, especially for a two-roll casting machine, with water cooling whereby cooling water is fed to cooling channels in the form of cooling bores or cooling grooves which are distributed about the roll periphery and is then carried off, and with a pressure chamber which is bounded by a roll shell and is controllably in connection with a pressure medium source, characterized in that, the roll shell (5) starting from sealing elements (15) has an increasing internal diameter toward the roll center and the hollow chamber (16) which is formed is pressurizable with the pressure medium for profile change.

2. The casting roll according to claim 1, characterized in that, the inner profile (5d) of the roll shell (5) is matched to the negative roll profile (1a) and that by means of the pressure application in casting operation, the required profile is set.

3. The casting roll according to claim 1, characterized in that, the increase in the diameter of the inner profile (5d) is symmetrical with respect to the roll center.

4. The casting roll according to one of the claims 1 to 3, characterized in that, the pressure medium is supplied radially or axially.

5. The casting roll according to one of the claims 1 to 4, characterized in that, the roll shell (5) is rotatably arranged on a stationary axle (2).

6. The casting roll according to one of the claims 1 to 4, characterized in that, the roll shell (5) is arranged on a rotatably journaled shaft (17).

7. The casting roll according to one of the claims 1 to 6, characterized in that, the ends (5d; 5b) of the roll shell (5) respectively have a supply annular housing (6) and a discharge annular housing (7) for the cooling water which flows in cooling channels (8) of the roll shell (5) parallel to the axis.

8. The casting roll according to one of the claims 1 to 7, characterized in that, the pressure liquid is fed by means of a rotary feedthrough (9) into a hydraulic chamber (10).

9. The casting roll according to claim 8, characterized in that, the pressure liquid is fed by means of a further rotary feedthrough—annular housing (11) fast ned on the inner sleeve part (4) through at least one radial pressure channel and one axial pressure channel (12; 13) into the hydraulic chamber (10).

10. The casting roll according to one of the claims 1 to 9, characterized in that, the formation of the wall thickness (5d) is effected over different internal diameters.

11. The casting roll according to one of the claims 1 to 10, characterized in that, the roll profile (1a) of the deformable roll shell (5) is adjustable by means of the fluid pressure in dependence upon the casting parameters.

12. The casting roll according to one of the claims 1 to 11, characterized in that, the roll profile (1a) of the deformable roll shell (5) is adjustable by the fluid pressure in dependence upon the adjustable force which is effective upon the roll body (1).

13. The casting roll according to one of the claims 1 to 6, characterized in that, the roll profile (1a) of the deformable roll shell (5) is adjustable through the liquid pressure in dependence upon the temperature profile of the roll shell (5).

14. The casting roll according to one of the claims 1 to 13, characterized in that, the pressure of the pressure liquid is adjustable between 50 and 500 bar.
